(19) United States
(12) Patent Application Publication
(10) Pub. No.: US 2024/0346685 A1
(43) Pub. Date: Oct. 17, 2024

(54) INTERACTIVE VISUAL EFFECTS USING POSE RECOGNITION

(71) Applicant: Adobe Inc., San Jose, CA (US)

(72) Inventors: Cuong NGUYEN, San Francisco, CA (US); Kazi Rubaiat HABIB, Seattle, WA (US); Yongqi ZHANG, Fairfax, VA (US)

(73) Assignee: Adobe Inc., San Jose, CA (US)

(21) Appl. No.: 18/299,552

(22) Filed: Apr. 12, 2023

(51) Int. Cl. G06T 7/73; G06V 10/74; G06V 10/764

(52) U.S. Cl. CPC G06T 7/73; G06V 10/761; G06V 10/764; G06T 2207/20044

(57) ABSTRACT

Embodiments are disclosed for interactive pose-based graphic effects. The method includes receiving an image including at least one object having a pose, the pose defined by an orientation and a position of the object within the image. A set of key joint data that represents the orientation and position of one or more points of interest associated with the object is generated. A vector representation of the set of key joint data is created for classifying one or more additional images that each include a candidate pose. One or more additional images are received. A match is detected between one of the candidate poses in the one or more additional images and the pose by comparing the vector representation of the set of key joint data to the candidate pose. A visual effect is generated based on the match.

### BACKGROUND

In the field of visual graphics, pose estimation provides a technique to detect positions of objects in an image or video. Human pose estimation involves identifying and tracking various points of a human body. Applying visual effects to parts of the human body in an output can be programmatically challenging for an average user. Typical pose estimation systems create effects that are coded for specific poses and requires extensive programming that is not flexible enough for modern graphics design.

### SUMMARY

Introduced here are techniques/technologies that relate to interactive pose-based graphic effects using a node architecture. This provides a workflow that eliminates the need for users to have extensive knowledge of coding and pose models. To create interactive pose-based graphic effects, a pose is input to a machine learning model that is trained to generate a vector representation of the pose. This vector representation is used by a node architecture that can classify other poses as matching the pose.

To classify the other poses, a designer can insert a node into the node architecture that recognizes poses by comparing vector representations of two poses. The node architecture can include other nodes to perform other functions such as another pose recognizer node. By including two recognizer nodes, the node architecture detects two poses that an object (e.g., images of a video stream) transitions between (e.g., weightlifting). The node architecture includes other nodes that provide a counter that increments for each correct repetition, stores the number of correct repetitions, and renders the number as a graphic effect. The nodes

Additional features and advantages of exemplary embodiments of the present disclosure will be set forth in the description which follows, and in part will be obvious from the description, or may be learned by the practice of such exemplary embodiments.

### BRIEF DESCRIPTION OF THE DRAWINGS

The detailed description is described with reference to the accompanying drawings in which:

FIG. 1 illustrates a diagram of a process of generating interactive pose-base graphic effects using a node architecture in accordance with one or more embodiments;

FIG. 2 illustrates a visual representation of generating key joint data from an input image in accordance with one or more embodiments;

FIG. 3 illustrates an example of configuring recognizer nodes to recognize candidate poses in accordance with one or more embodiments;

FIG. 4 depicts an example of detecting pose matches with the candidate poses to generate interactive pose-base graphic effects using a node architecture in accordance with one or more embodiments;

FIG. 5 illustrates an example of interactive pose-base graphic effects in accordance with one or more embodiments;

FIG. 6 illustrates a schematic diagram of a vector graphics system in accordance with one or more embodiments;

FIG. 7 illustrates a flowchart of a series of acts in a method of generating recommended layouts from design inputs in accordance with one or more embodiments;

FIG. 8 illustrates a schematic diagram of an exemplary environment in which the vector graphics system can operate in accordance with one or more embodiments; and

FIG. 9 illustrates a block diagram of an exemplary computing device in accordance with one or more embodiments.

### DETAILED DESCRIPTION

One or more embodiments of the present disclosure include a vector graphics system for generating interactive visual effects using pose recognition. In vector graphics, graphic effects that are reactive to motion graphics in a video are used to augment the video with additional visual features. These additional visual features change depending on motion of one or more objects in the video frames.

Designing interactive graphics effects that use human pose recognition is often time consuming. It normally requires extensive programming that is not flexible enough for modern graphics effects use. In existing techniques, a designer writes a program that selects key joint data from a defined set of key joints, and then writes a separate program that adds visual effects. However, these programs are not adaptable to adjust key joints or changes in pose as the programs are limited by the programming during design. Consequently, existing techniques do not provide an accessible or scalable process for most graphic designers.

To address these and other deficiencies in conventional systems, embodiments provide interactive graphic effects through a node architecture. Key joint data that represents a human pose is generated from received or captured images. The key joint data is generated by a trained machine learning model that is trained to generate vector representations of poses in images. The vector representations are input into a node architecture that includes nodes to perform recognition of poses, implement logic, store data values, transform data values, and render visual effects to an output image.

Embodiments described herein provide a flexible approach for generating graphic effects using a node architecture and pose recognition to produce effects that are reactive to a pose detected in an image. By using the trained machine learning model to generate vector representations of the poses in images, the node architecture can detect multiple poses in a stream of images such as a video and apply visual effects to output images. Different combinations of nodes can produce different visual effects such as counting, controlling a speed or size of a visual effect, or other visual effects.

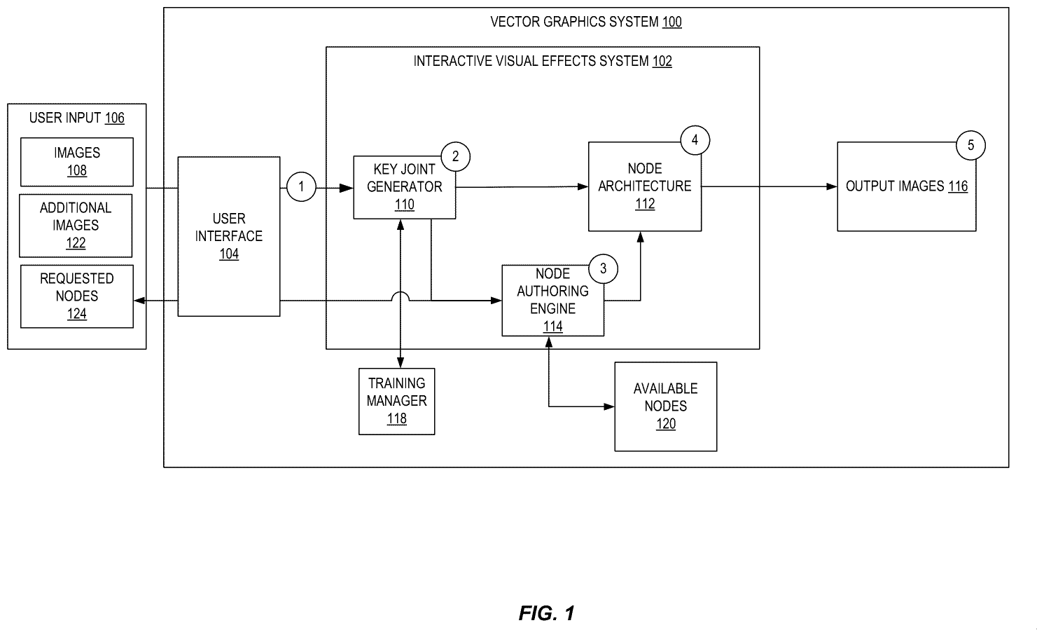

FIG. 1 illustrates a diagram of a process of generating interactive pose-based graphic effects using a node architecture in accordance with one or more embodiments. As depicted in FIG. 1, a vector graphics system 100 includes an interactive visual effects system 102 that includes key joint generator 110, node architecture 112, and node authoring engine 114. The vector graphics system 100 includes a user interface 104 that user input 106. In some embodiments, the key joint generator 110, node architecture 112, or node authoring engine 114 is implemented as a module in the interactive visual effects system 102 or another computing application.

At numeral 1, the key joint generator 110 obtains user input 106 from the user interface 104. The user input 106 includes a selection of images 108 for generating interactive pose-based graphic effects. In some embodiments, the images are captured from a camera device communicatively coupled to the vector graphics system 100. The images 108 include at least one object having a pose. The pose of each object in the image is defined by an orientation and the position of the object within the image. In some embodiments, the user input includes an additional image 122 that includes the object having a candidate pose that may be different from the pose. The candidate poses are poses that can be matched with the pose in the images 108 as described below. In some embodiments, the user input 106 also include a set of requested nodes 124. The set of requested nodes includes an arrangement of nodes to be generated by the node authoring engine. The set of nodes identifies particular types of nodes (e.g., functions of nodes), and the arrangement defines the logic of nodes such as recognizing two poses and counting a number of transitions between the two poses. Additional details of the set of requested nodes 124 are described below.

At numeral 2, the key joint generator 110 creates a set of key joint data to represent the orientation and position of one or more points of interest for the objects in the images 108. The set of key joint data includes a coordinate (x, y) for each point of interest. In an example, points of interest for a pose of a human in an image include elbows, wrists, fingertips, neck, and/or head. In some embodiments, the key joint data includes color, orientation, and other attributes of the point of interest. To represent the more than one point of interest, the key joint generator 110 creates a vector representation of the set of key joint data including multiple coordinates that each correspond to a point of interest. For instance, the vector representation for a human pose includes coordinates of (1) elbow(s), (2) wrist(s), (3) fingertip(s), (4) neck, and/or (5) head such as [(x₁, y₁, θ₁); (x₂, y₂, θ₂); (x₃, y₃, θ₃); (x₄, y₄, θ₄); (x₅, y₅, θ₅)].

Prior to generating a set of key joint data, the key joint generator 110 is trained by the training manager 118. For example, the key joint generator is a two-stage machine learning model. The first stage is trained to detect a region of interest such as a human, animal, etc., within the image that has a pose. After detecting the region of interest, the second stage of the key joint generator 110 predicts positions of the points of interest using image segmentation and the region of interest. The positions of the points of interest are produced as the vector representation described above. Additional details on the key joint generator are described below.

At numeral 3, the node authoring engine 114 generates a node architecture based on a user selecting and arranging a set of available nodes. The selection of nodes includes various types of nodes that each perform functions for generating the interactive graphic video effects. To select the nodes, the node authoring engine 114 accesses available nodes 120 in response to a user request. Available nodes 120 includes multiple types of nodes that are used to generate interactive graphic effects from the node architecture 112. Each type of node performs a function as described below to generate interactive graphic effects. The node authoring engine 114 may present a set of available nodes to the user via user interface 104, as shown at 3. In some embodiments, this may be presented to the user as a request for a selection of nodes and an arrangement of the nodes in a node architecture by the user of the user interface 104. The node authoring engine 114 may receive a set of requested nodes 124 in response to the request. The set of requested nodes 124 may include any combination of the available nodes 120 in any arrangement as described below. The set of requested nodes 124 can include multiple nodes of the same type. In some embodiments, the node authoring engine 114 stores the node architecture 112 for subsequent use with other images or videos.

In some embodiments, the available nodes 120 include recognizer nodes, compound nodes, data nodes, transform nodes, and/or render nodes. A recognizer node is used to create a pose-based trigger that is activated when a matching pose is detected. The recognizer node is provided with a candidate pose during a configuration process and outputs a “TRUE” value when a matching pose is received during run-time. A single recognizer node detects a single pose while a series of connected recognizer nodes detects a sequence of poses, such as a transition between poses. In some embodiments, the recognizer node receives a vector representation of a candidate pose that is used to compare other vector representations of poses. The recognizer node computes a similarity between the vector representations to determine a match between two poses.

A compound node is used to implement a logic gate such as by receiving two outputs from other nodes and implementing a logic function. For example, the compound node is used to implement an “AND” gate when the compound node receives outputs from two nodes and outputs a “TRUE” when both inputs to the compound node are “TRUE.” In another example, the compound node is used to implement an “OR” gate when the compound node receives inputs from two nodes and outputs a “TRUE” when one of the inputs is “TRUE.”

A data node stores values such as a key joint coordinate, a number (e.g., counting pose transitions), a logic value, or a string. For example, the data node can store a coordinate of a key joint that can be added to the video effect as an annotation of the location of the key joint. A transform node is used to perform mathematical operations on values stored in a data node. Examples of operations performed by the transform node include arithmetic, vector, or statistical operations. In an example, if a data node stores a value of “2” and the transform node is configured to multiply by 2, the output of the transform node is “4.” A render node takes input and renders visual effects to images. For example, the render node can render outputs of a data node or a transform node to an image. Continuing to the previous example, the output of the transform node is “4” and the number “4” is rendered onto the image, such as an output image described below.

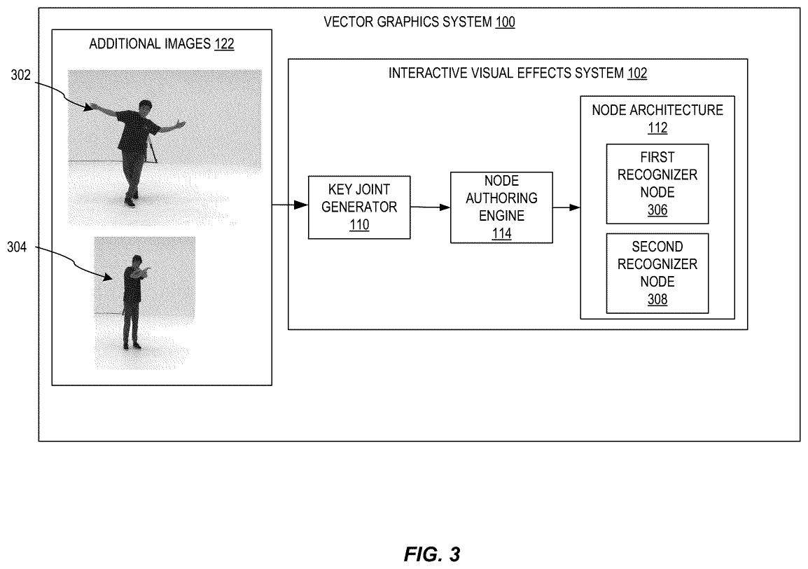

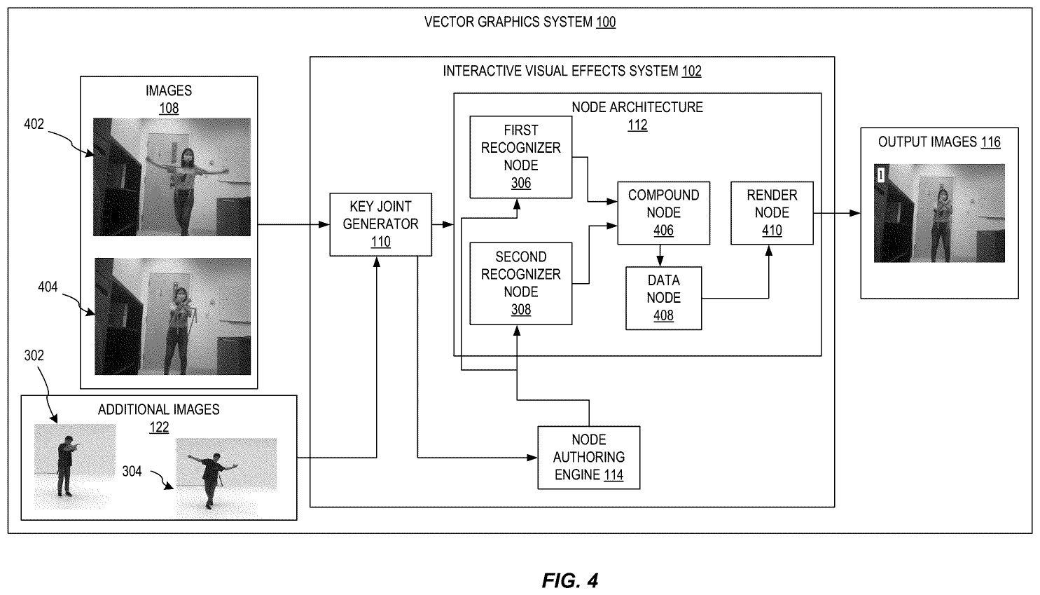

At numeral 4, the node architecture 112 receives the vector representation of the set of key joint data and the selection of nodes. The node architecture 112 applies the selection of nodes to the set of key joint data to generate the interactive visual effect. In an example, the node authoring engine 114 generates a selection of nodes that includes two recognizer nodes, a compound node configured as an “AND” gate, a data node that counts the output of the compound node, and a render node. The node architecture 112 applies this selection of nodes to the user input 106 including the images 108 and the additional images 122. By applying the selection of nodes, the node architecture 112 detects two different poses, and after both poses are matched, increments a data counter to be rendered as a video effect. Additional details of this example are described below with reference to FIGS. 3-4.

At numeral 5, the interactive visual effects system 102 outputs a set of output images 116. The set of output images 116 includes the images 108 and the video effects inserted by the node architecture 112. The set of output images 116 can be presented to the user via a user interface or stored in a cache or non-volatile memory device.

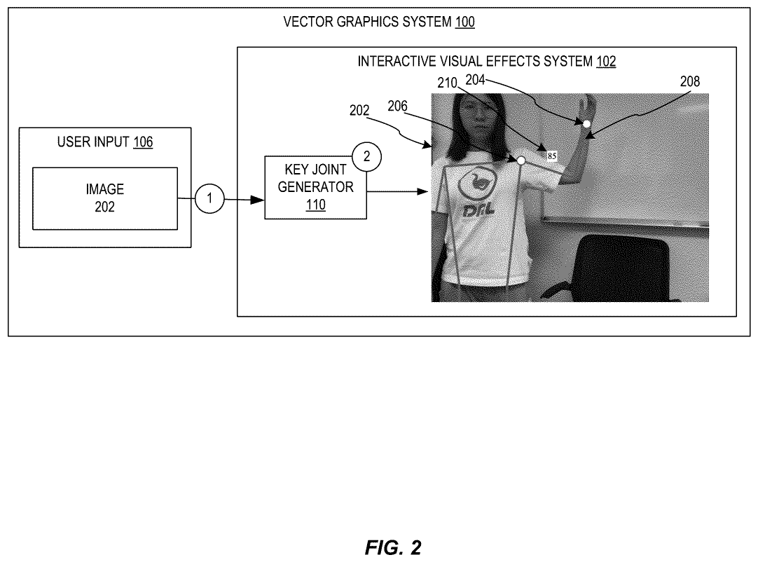

FIG. 2 illustrates a visual representation of generating key joint data from an input image in accordance with one or more embodiments. For instance, key joint generator 110 receives the image 202 that includes an object with a pose as described above. As illustrated by FIG. 2, the key joint generator 110 identifies a first key joint 204 (e.g., a wrist) and a second key joint 206 (e.g., a shoulder) in the image 202. The key joint generator 110 also identifies a wireframe 208 that connects the first key joint and the second key joint 206. A portion of the wireframe 208 between the first key joint 204 and the second key joint 206 includes a reference angle 210 of 85 degrees. The reference angle 210 is the angular change in direction of the portion of the wireframe 208. While FIG. 2 depicts two key joints, any number of key joints can be identified. As an example, an additional key joint can be identified at the location of the angular change (e.g., an elbow) in the portion of the wireframe 208. As illustrated in FIG. 2, the key joints are annotated in the image 202, however, the key joint generator 110 can represent the set of key joint data as a vector representation of the coordinates.

FIG. 3 illustrates an example of configuring recognizer nodes to recognize candidate poses in accordance with one or more embodiments. As described above, the interactive visual effects system 102 can receive additional images 122 that include the object having a first candidate pose 302 and a second candidate pose 304. The key joint generator 110 creates sets of key joint data to represent the first candidate pose 302 and the second candidate pose 304. As described above, the node authoring engine 114 can select two recognizer nodes, with a first recognizer node 306 configured to detect the first candidate pose 302, and a second recognizer node 308 configured to detect the second candidate pose 304. The node authoring engine 114 inserts the first recognizer node 306 and the second recognizer node 308 into the node architecture 112. After the insertion of the first recognizer node 306 and the second recognizer node 308 into the node architecture 112, the node architecture 112 can detect matches between the first candidate pose 302 or the second candidate pose 304 and a pose from the images 108. Pose matching is described in additional detail with reference to FIG. 4.

FIG. 4 depicts an example of detecting pose matches with the candidate poses to generate interactive pose-based graphic effects using a node architecture in accordance with one or more embodiments. As described above, the interactive visual effects system 102 can receive additional images 122 that include in a first candidate pose 302 and a second candidate pose 304. As further described above, the node authoring engine 114 generates a node architecture in response to receiving a set of requested nodes from a user. In this example, the node architecture includes two recognizer nodes 306, 308, a compound node 406, a data node 408, and a render node 410. The first recognizer node 306, as described with reference to FIG. 3, is configured to detect the first candidate pose 302, and the second recognizer node 308, as described with reference to FIG. 3, is configured to detect the second candidate pose 304. The compound node 406 implements an “AND” logic gate such that the output to the data node is “TRUE” after the first candidate pose 302 and the second candidate pose 304 have been recognized by corresponding recognizer nodes. The data node 408 increments a counter for each “TRUE” input from the compound node 408 and outputs the value of the counter to the render node 410. The render node 410 annotates output images 116 with a number representing the value of the counter.

In order to determine matching poses, the images 108 are received by the interactive visual effects system 102 as described above. The images 108 include a first pose 402 and a second pose 404. The key joint generator 110 creates a vector representation of the first pose 402 and the second pose 404. The vector representation of the first pose 402 is provided to the node architecture 112 by the key joint generator 110. The node architecture 112 detects a match between the first pose 402 and the first candidate pose 302. The first recognizer node 306 outputs a value of “TRUE” after determining the pose match. During this time, the second recognizer node 308 outputs a value of “FALSE” because the first pose 302 does not match the second candidate pose 304. When the second pose 404 is received, such as when the subject in a camera feed transitions from the first pose 402 to the second pose 404, the vector representation of the second pose 404 is provided to the node architecture 112 by the key joint generator 110. The node architecture 112 detects a match between the second pose 404 and the second candidate pose 304. The second recognizer node 308 outputs a value of “TRUE” after determining the second pose match. After receiving a value of “TRUE” from the first recognizer node 306 and the second recognizer node 308, the compound node 406 outputs “TRUE” to the data node 408. The data node 408 increments a counter for the “TRUE” input from the compound node 408 and outputs the value of the counter to the render node 410. The render node 410 annotates output images 116 with a number “1” representing the value of the counter.

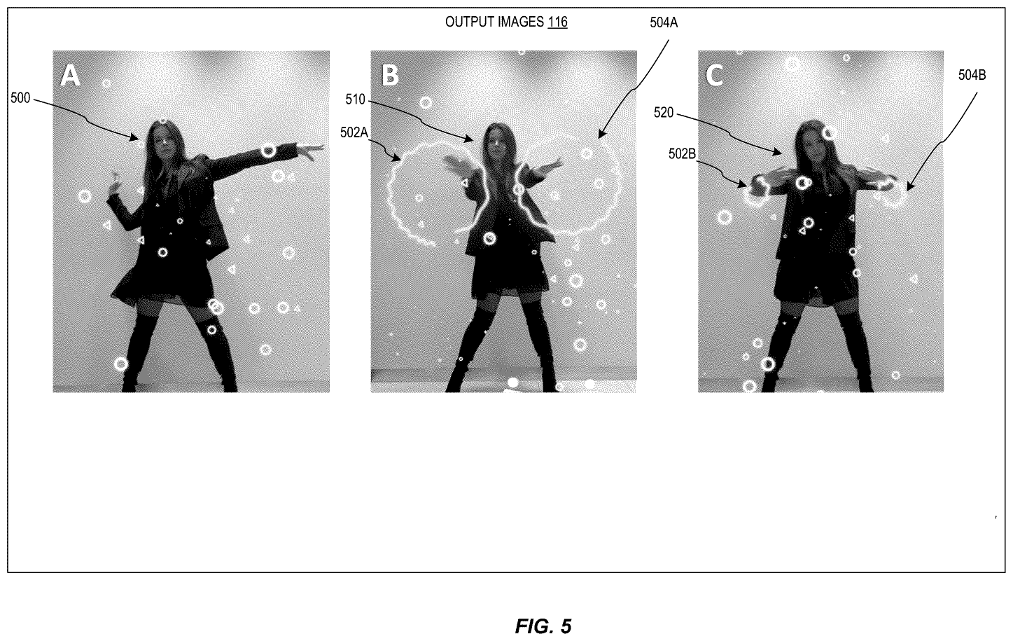

FIG. 5 illustrates an example of interactive pose-based graphic effects in accordance with one or more embodiments. As described above, the interactive pose-base graphic effects are generated by applying the node architecture to the received images. As illustrated in FIG. 5, as a pose 500 that is detected by a recognizer node of the node architecture changes to a different pose 510 that is detected by a different recognizer node of the node architecture, a visual effect (e.g., a stylized circle) having a first position 502A is added to the output image such as by a combination of data, transform, or render nodes as described above. Additionally, as the pose 500 changes to pose 510, a second visual effect (e.g., another stylized circle) having a first position 504A is added to the output image. After the pose 510 transitions to pose 520, the visual effect having a first position 502A is decreased in size and is displaced to the second position 502B. Similarly, after the pose 510 transitions to pose 520, the second visual effect having a first position 504A is decreased in size and is displaced to the second position 504B.

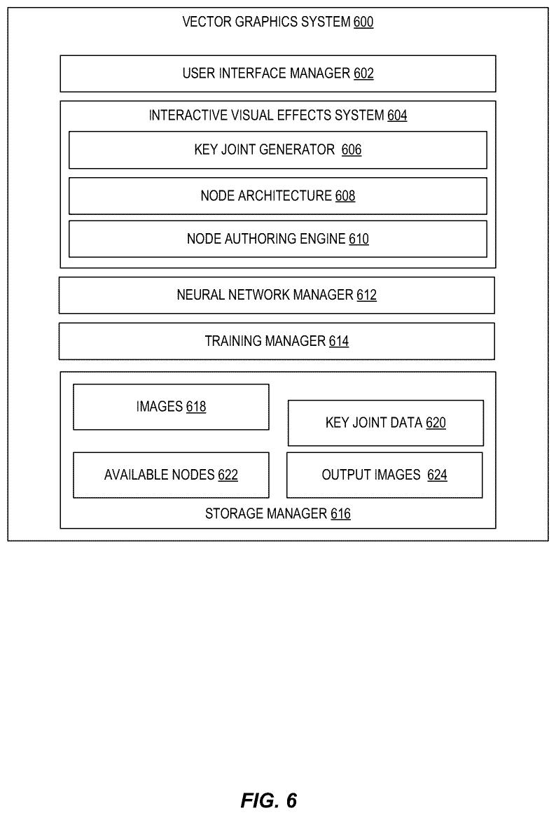

FIG. 6 illustrates a schematic diagram of a vector graphics system 600 including an interactive visual effects system 604 in accordance with one or more embodiments. As shown, the vector graphics system 600 may include but is not limited to user interface manager 602, interactive visual effects system 604, neural network manager 612, training manager 614, and storage manager 616. The interactive visual effects system 604 includes key joint generator 606, node architecture 608, and node authoring engine 610. The storage manager 616 includes images 618, key joint data 620, available nodes 622, and output images 624.

As illustrated in FIG. 6, the vector graphics system 600 includes a user interface manager 602. For example, the user interface manager 602 allows users to select images 618 for generating interactive visual effects by the vector graphics system 600. In some embodiments, the user interface manager 602 provides a user interface through which the user can upload one or more files that include the images or select each image from an existing video (e.g., a keyframe selection). Alternatively, or additionally, the user interface manager 602 may enable the user to download the output images 624 from a local or remote storage location (e.g., by providing an address (e.g., a URL or other endpoint) associated with output images 624. In some embodiments, the user interface manager 602 can enable a user to render a series of output images 624 into a video stream or a video file.

As illustrated in FIG. 6, the vector graphics system 600 includes an interactive visual effects system 604. The interactive visual effects system 604 receives images 618 that include an object having a pose and generates an output image 624 having a pose-based visual effect using the key joint generator 606, the node architecture 608, and the node authoring engine 610. The interactive visual effects system 604 outputs the output images 624 (or a video including a series of output images 624) to the user interface of the user interface manager 602.

As illustrated in FIG. 6, the interactive visual effects system 604 includes a key joint generator 606. The key joint generator 606 is a trained machine learning model that creates key joint data to represent the orientation and position of each point of interest in the images 108. The set of key joint data includes at least a position coordinate (x, y) for each point of interest. As described above with reference to a human pose, points of interest include physiological regions such as elbows, wrists, ankles, feet, fingertips, neck, and/or head. To represent an object that includes multiple points of interest, the key joint generator 606 creates a vector representation as described above.

As illustrated in FIG. 6, the interactive visual effects system 604 includes a node architecture 608. As described above, the node architecture 608 applies a selection of nodes to the set of key joint data to generate the interactive visual effect for output images 624. The node architecture 608 includes various types of nodes for detecting poses, implementing logic, storing data values, performing transformation operations on the data values, and rendering the data values or output of the transformation operation to output images 624.

As illustrated in FIG. 6, the interactive visual effects system 604 includes a node authoring engine 610. The node authoring engine 610 selects nodes for the node architecture 608. The selection of nodes includes various types of nodes that perform functions for generating the interactive graphic video effects. To select the nodes, the node authoring engine may provide a set of available nodes to the user interface manager 602 with a request for an arrangement of nodes by the user. Using the user's selection of nodes, the node authoring engine 610 creates the node architecture 608.

As illustrated in FIG. 6, the vector graphics system 600 also includes a neural network manager 612. Neural network manager 612 may host a plurality of neural networks or other machine learning models, such as key joint generator 606. The neural network manager 612 may include an execution environment, libraries, and/or any other data needed to execute the machine learning models. In some embodiments, the neural network manager 612 may be associated with dedicated software and/or hardware resources to execute the machine learning models. As discussed, key joint generator can be implemented as any type of one-shot pose embedding model, such as Pr-VIPE, or other pose recognition models. Although depicted in FIG. 6 as being part of the interactive visual effects system 604, the key joint generator 606 can be hosted by a neural network manager 612, and/or as part of different components.

As illustrated in FIG. 6 the vector graphics system 600 also includes training manager 614. The training manager 614 can teach, guide, tune, and/or train one or more neural networks. In particular, the training manager 614 can train a neural network based on a plurality of training data. For example, the key joint generator 606 can be trained to generate vector representations of poses for objects in images. Additionally, the key joint generator 606 may be further optimized using a loss function, such as L2 loss to create vector representations of the pose that accurately reflect the key joint data for the pose. More specifically, the training manager 614 can access, identify, generate, create, and/or determine training input and utilize the training input to train and fine-tune a neural network. For instance, the training manager 614 can train the key joint generator 606, end-to-end, as discussed above.

As illustrated in FIG. 6, the vector graphics system 600 also includes the storage manager 616. The storage manager 616 maintains data for the vector graphics system 600. The storage manager 616 can maintain data of any type, size, or kind as necessary to perform the functions of the vector graphics system 600. The storage manager 616, as shown in FIG. 6, includes the images 618. The images 618 can include a plurality of images files that are captured from a video camera coupled to the user interface manager 602. In particular, the images 618 include objects having a pose that are used by the interactive visual effects system 604 to generate pose-based video effects.

As further illustrated in FIG. 6, the storage manager 616 also includes key joint data 620. The key joint data 620 can include information used as input to the node architecture 608 or the node authoring engine 610 and represents the pose of an object in the images 618 in a vector representation. Key joint data 620 includes vector representations poses in images 618 and also candidate poses that are generated from additional images and processed by the interactive visual effects system 604.

As further illustrated in FIG. 5, the storage manager 616 also includes available nodes 622. The available nodes 622 may include multiple types of nodes that perform a function to generate interactive graphic effects. As described above, examples of available nodes 622 include recognizer nodes, compound nodes, data nodes, transform nodes, and render nodes. Other types of nodes can also be included in the available nodes 622.

As further illustrated in FIG. 6, the storage manager 616 also includes output images 624. The output images 624 are files that include visual effects inserted by the node architecture based on the selected nodes arranged in a particular configuration of the node architecture. The output images 624 are generated by the node architecture 608 and can be presented to the user via the user interface manager 602.

Each of the components 602-616 of the vector graphics system 600 and their corresponding elements (as shown in FIG. 6) may be in communication with one another using any suitable communication technologies. It will be recognized that although components 602-616 and their corresponding elements are shown to be separate in FIG. 6, any of components 602-616 and their corresponding elements may be combined into fewer components. As such a single facility or module, divided into more components, or configured into different components may serve a particular embodiment.

The components 602-616 and their corresponding elements can comprise software, hardware, or both. For example, the components 602-616 and their corresponding elements can comprise one or more instructions stored on a computer-readable storage medium and executable by processors of one or more computing devices. When executed by the one or more processors, the computer-executable instructions of the vector graphics system 600 can cause a client device and/or a server device to perform the methods described herein. Alternatively, the components 602-616 and their corresponding elements can comprise hardware, such as a special purpose processing device to perform a certain function or group of functions. Additionally, the components 602-616 and their corresponding elements can comprise a combination of computer-executable instructions and hardware.

Furthermore, the components 602-616 of the vector graphics system 600 may, for example, implement as one or more stand-alone applications or as one or more modules of an application. Also, as one or more plug-ins, as one or more library functions and/or functions that may be called by other applications, and/or as a cloud-computing models. Thus, the components 602-616 of the vector graphics system 600 may be implemented as a stand-alone application, such as a desktop or mobile application. Furthermore, the components 602-616 of the vector graphics system 600 may be implemented as one or more web-based applications hosted on a remote server. Alternatively, or additionally, the components of the vector graphics system 600 may be implemented in a suite of mobile device applications or “apps.”

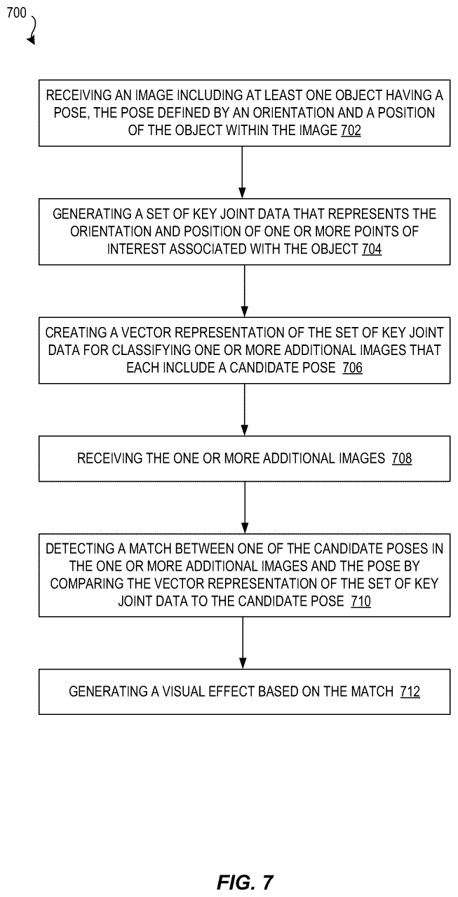

FIGS. 1-6, the corresponding text, and the examples, provide a number of different systems and devices that allow a user to generate recommended layouts from the design inputs identified by design input selections. In addition to the foregoing, embodiments can also be described in terms of flowcharts comprising acts and steps in a method for accomplishing a particular result. For example, FIG. 7 illustrates a flowchart of an exemplary method in accordance with one or more embodiments. The method described in relation to FIG. 7 may be performed with fewer or more steps/acts or the steps/acts may be performed in differing orders. Additionally, the steps/acts described herein may be repeated or performed in parallel with one another or in parallel with different instances of the same or similar steps/acts.

FIG. 7 illustrates a flowchart of a series of acts in a method of generating interactive pose-based graphic effects using a node architecture in accordance with one or more embodiments. In one or more embodiments, the method 700 is performed in a digital medium environment that includes the vector graphics system 600. The method 700 is intended to be illustrative of one or more methods in accordance with the present disclosure and is not intended to limit potential embodiments. Alternative embodiments can include additional, fewer, or different steps than those articulated in FIG. 7.

As illustrated in FIG. 7, the method 700 includes an act 702 of receiving an image including at least one object having a pose, the pose defined by an orientation and a position of the object within the image. As described above, the key joint generator receives images that include at least one object having a pose. In some embodiments, the key joint generator receives additional images that include objects having a candidate pose.

As illustrated in FIG. 7, the method 700 includes an act 704 of generating a set of key joint data that represents the orientation and position of one or more points of interest associated with the object. As described above, the key joint generator is trained to detect a region of interest within the image that has a pose. After detecting the region of interest, the key joint generator predicts points of interest using image segmentation and the region of interest. The positions of the points of interest are output as the vector representation.

In some embodiments, to generate the set of key joint data includes applying a trained machine learning model (e.g., the key joint generator 110) to the image including the object. Applying the trained machine learning model includes detecting a type of the object, the type indicating a set of points that are defined for each object. After detection of the type of the object, the trained machine learning model detects a position and orientation for each point in the set of points and inserts the position and orientation of each point into the set of key joint data.

As illustrated in FIG. 7, the method 700 includes an act 706 of creating a vector representation of the set of key joint data for classifying one or more additional images that each include a candidate pose. As described above, key joint generator generates a vector that represents position and other attributes of each key joint. The vector representation is used by the node authoring engine to generate recognizer nodes that compare poses in received images with the pose corresponding to the vector representation as described above.

As illustrated in FIG. 7, the method 700 includes an act 708 of receiving the one or more additional images. As described above, the interactive visual effect system can receive additional images for generating candidate poses to detect matches to the pose of the image received during act 702. Further as described above, each of the one or more additional images is processed by the key joint generator to produce a candidate pose that is used by the recognizer nodes of the node architecture.

As illustrated in FIG. 7, the method 700 includes an act 710 of detecting a match between one of the candidate poses in the one or more additional images and the pose by comparing the vector representation of the set of key joint data to the candidate pose. As described above, the node architecture can include recognizer nodes that each compare the pose to a candidate pose. For example, the matches are detected by comparing, by the node architecture, a key joint of the pose to a corresponding key joint of the candidate pose. After performing the comparison, the node architecture determines if the key joint of the pose matches a corresponding key joint of the candidate pose. In some embodiments, the node architecture uses recognizer nodes to compute a similarity of multiple key joints of the pose to corresponding key joints of the candidate pose.

As illustrated in FIG. 7, the method 700 includes an act 712 of generating a visual effect based on the match. As described above, the interactive visual effect system can select a visual effect for insertion into the image if a pose match is determined. In response to determining that key joint of the pose matches the corresponding key joint of the candidate pose, inserting the selected visual effect into the image. In some embodiments, the visual effect is selected from a library of visual effects or can be provided by the user as an additional user input. In an example, the visual effect is applied to a specific key joint and updated as the key joint changes as described above. For instance, the visual effect is applied at a key joint by identifying an effect key joint of the pose where the visual effect is to be added; and applying the visual effect at a position of the effect key joint in the image.

In some embodiments, the method 700 also includes receiving a second image including at least one object having an additional pose, the additional pose defined by an additional orientation and an additional position of the object within the image. As described above with reference to FIG. 4, the key joint generator creates an additional set of key joint data that represents the additional orientation and additional position of the one or more points of interest for the object. For example, the second image may include the same object but in a different pose, such as described above to detect transitions between two poses. To detect the transition between two poses, the key joint generator creates a vector representation of the additional set of key joint data and the node architecture detects an occurrence of the pose at a first time interval in response to receiving the one or more additional images. The node architecture detects an occurrence of the additional pose at a second time interval in response to receiving the one or more additional images. After both the pose and the additional pose have been detected, the node architecture generates a visual effect.

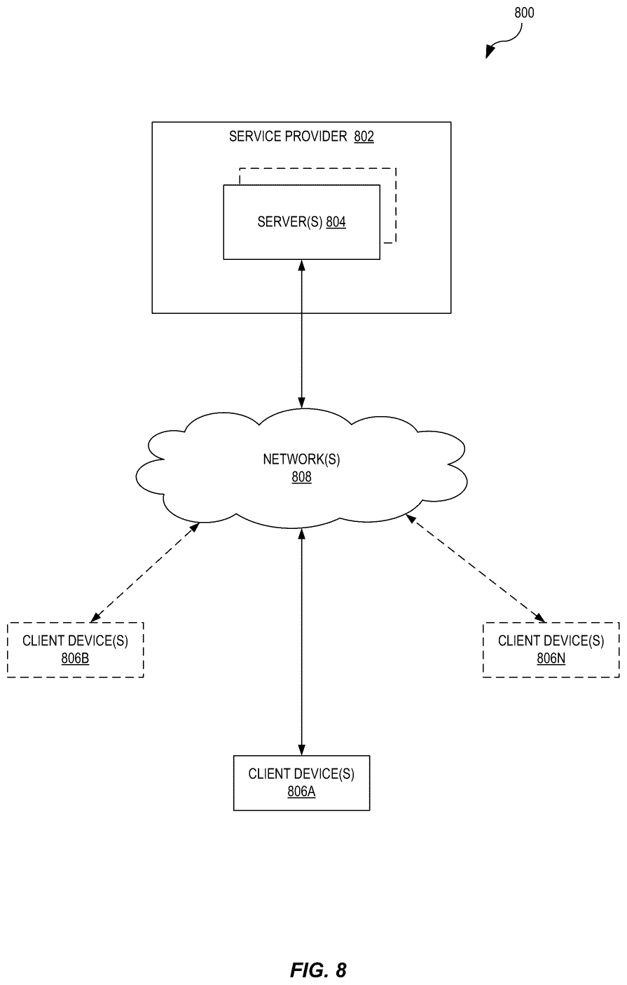

FIG. 8 illustrates a schematic diagram of an exemplary environment 800 in which the vector graphics system 600 can operate in accordance with one or more embodiments. In one or more embodiments, the environment 800 includes a service provider 802 which may include one or more servers 804 connected to a plurality of client devices 806A-806N via one or more networks 808. The client devices 806A-806N, the one or more networks 808, the service provider 802, and the one or more servers 804 may communicate with each other or other components using any communication platforms and technologies suitable for transporting data and/or communication signals, including any known communication technologies, devices, media, and protocols supportive of remote data communications. Such examples of which will be described in more detail below with respect to FIG. 8.

Although FIG. 8 illustrates a particular arrangement of the client devices 806A-806N, the one or more networks 808, the service provider 802, and the one or more servers 804, various additional arrangements are possible. For example, the client devices 806A-806N may directly communicate with the one or more servers 804, bypassing the network 808. Or alternatively, the client devices 806A-806N may directly communicate with each other. The service provider 802 may be a public cloud service provider which owns and operates their own infrastructure in one or more data centers and provides this infrastructure to customers and end users on demand to host applications on the one or more servers 804. The servers may include one or more hardware servers (e.g., hosts), each with its own computing resources (e.g., processors, memory, disk space, networking bandwidth, etc.) which may be securely divided between multiple customers, each of which may host their own applications on the one or more servers 804. In some embodiments, the service provider may be a private cloud provider which maintains cloud infrastructure for a single organization. The one or more servers 804 may similarly include one or more hardware servers, each with its own computing resources, which are divided among applications hosted by the one or more servers for use by members of the organization or their customers.

Similarly, although the environment 800 of FIG. 8 is depicted as having various components, the environment 800 may have additional or alternative components. For example, the environment 800 can be implemented on a single computing device with the vector graphics system 600. In particular, the vector graphics system 600 may be implemented in whole or in part on the client device 806A.

As illustrated in FIG. 8, the environment 800 may include client devices 806A-806N. The client devices 806A-806N may comprise any computing device. For example, client devices 806A-806N may comprise one or more personal computers, laptop computers, mobile devices, mobile phones, tablets, special purpose computers, TVs, or other computing devices, including computing devices described below with regard to FIG. 8. Although three client devices are shown in FIG. 8, it will be appreciated that client devices 806A-806N may comprise any number of client devices (greater or smaller than shown).

Moreover, as illustrated in FIG. 8, the client devices 806A-806N and the one or more servers 804 may communicate via one or more networks 808. The one or more networks 808 may represent a single network or a collection of networks (such as the Internet, a corporate intranet, a virtual private network (VPN), a local area network (LAN), a wireless local network (WLAN), a cellular network, a wide area network (WAN), a metropolitan area network (MAN), or a combination of two or more such networks. Thus, the one or more networks 808 may be any suitable network over which the client devices 806A-806N may access service provider 802 and server 804, or vice versa. The one or more networks 808 will be discussed in more detail below with regard to FIG. 8.

In addition, the environment 800 may also include one or more servers 804. The one or more servers 804 may generate, store, receive, and transmit any type of data, including images 618, key joint data 620, available nodes 622, output images 624, or other information. For example, a server 804 may receive data from a client device, such as the client device 806A, and send the data to another client device, such as the client device 802B and/or 802N. The server 804 can also transmit electronic messages between one or more users of the environment 800. In one example embodiment, the server 804 is a data server. The server 804 can also comprise a communication server or a web-hosting server. Additional details regarding the server 804 will be discussed below with respect to FIG. 8.

As mentioned, in one or more embodiments, the one or more servers 804 can include or implement at least a portion of the vector graphics system 600. In particular, the vector graphics system 600 can comprise an application running on the one or more servers 804 or a portion of the vector graphics system 600 can be downloaded from the one or more servers 804. For example, the vector graphics system 600 can include a web hosting application that allows the client devices 806A-806N to interact with content hosted at the one or more servers 804. To illustrate, in one or more embodiments of the environment 800, one or more client devices 806A-806N can access a webpage supported by the one or more servers 804. In particular, the client device 806A can run a web application (e.g., a web browser) to allow a user to access, view, and/or interact with a webpage or website hosted at the one or more servers 804.

Upon the client device 806A accessing a webpage or other web application hosted at the one or more servers 804, in one or more embodiments, the one or more servers 804 can provide access to images, key joint data, available nodes, or output images (e.g., images 618, key joint data 620, available nodes 622, output images 624, etc.) stored at the one or more servers 804. Moreover, the client device 806A can receive a request (i.e., via user input) to generate a recommended layout from a set of design inputs and provide the request to the one or more servers 804. Upon receiving the request, the one or more servers 804 can automatically perform the methods and processes described above to generate the interactive pose-based visual effects. The one or more servers 804 can provide all or portions of the recommended layout, to the client device 806A for presentation to the user.

As just described, the vector graphics system 600 may be implemented in whole, or in part, by the individual elements 802-808 of the environment 800. It will be appreciated that although certain components of the vector graphics system 600 are described in the previous examples with regard to particular elements of the environment 800, various alternative implementations are possible. For instance, in one or more embodiments, the vector graphics system 600 is implemented on any of the client devices 806A-806N. Similarly, in one or more embodiments, the vector graphics system 600 may be implemented on the one or more servers 804. Moreover, different components and functions of the vector graphics system 600 may be implemented separately among client devices 806A-806N, the one or more servers 804, and the network 808.

Embodiments of the present disclosure may comprise or utilize a special purpose or general-purpose computer including computer hardware, such as, for example, one or more processors and system memory, as discussed in greater detail below. Embodiments within the scope of the present disclosure also include physical and other computer-readable media for carrying or storing computer-executable instructions and/or data structures. In particular, one or more of the processes described herein may be implemented at least in part as instructions embodied in a non-transitory computer-readable medium. Thus, executable by one or more computing devices (e.g., any of the media content access devices described herein). In general, a processor (e.g., a microprocessor) receives instructions, from a non-transitory computer-readable medium, (e.g., a memory, etc.), and executes those instructions, thereby performing one or more processes, including one or more of the processes described herein.

Computer-readable media can be any available media that can be accessed by a general purpose or special purpose computer system. Computer-readable media that store computer-executable instructions are non-transitory computer-readable storage media (devices). Computer-readable media that carry computer-executable instructions are transmission media. Thus, by way of example, and not limitation, embodiments of the disclosure can comprise at least two distinctly different kinds of computer-readable media: non-transitory computer-readable storage media (devices) and transmission media.

Non-transitory computer-readable storage media (devices) includes RAM, ROM, EEPROM, CD-ROM, solid state drives (“SSDs”) (e.g., based on RAM), Flash memory, phase-change memory (“PCM”), other types of memory, other optical disk storage, magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information transfers or provided over a network or another communications connection (either hardwired, wireless, or a combination of hardwired or wireless) to a computer, the computer properly views the connection as a transmission medium. Transmissions media can include a network and/or data links which can be used to carry desired program code means in the form of computer-executable instructions or data structures and which can be accessed by a general purpose or special purpose computer. Combinations of the above should also be included within the scope of computer-readable media.

Further, upon reaching various computer system components, program code means in the form of computer-executable instructions or data structures that can be transferred automatically from transmission media to non-transitory computer-readable storage media (devices) (or vice versa). For example, computer-executable instructions or data structures received over a network or data link can be buffered in RAM within a network interface module (e.g., a “NIC”), and then eventually transferred to computer system RAM and/or to less volatile computer storage media (devices) at a computer system. Thus, it should be understood that non-transitory computer-readable storage media (devices) can be included in computer system components that also (or even primarily) utilize transmission media.

Computer-executable instructions comprise, for example, instructions and data which, when executed at a processor, cause a general-purpose computer, special purpose computer, or special purpose processing device to perform a certain function or group of functions. In some embodiments, computer-executable instructions are executed on a general-purpose computer to turn the general-purpose computer into a special purpose computer implementing elements of the disclosure. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the disclosure may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, tablets, pagers, routers, switches, and the like. The disclosure may also be practiced in distributed system environments where local and remote computer systems, which are linked (either by hardwired data links, wireless data links, or by a combination of hardwired and wireless data links) through a network, that both perform tasks. In a distributed system environment, program modules may be located in both local and remote memory storage devices.

Embodiments of the present disclosure can also be implemented in cloud computing environments. In this description, “cloud computing” is defined as a model for enabling on-demand network access to a shared pool of configurable computing resources. For example, cloud computing can be employed in the marketplace to offer ubiquitous and convenient on-demand access to the shared pool of configurable computing resources. The shared pool of configurable computing resources can be rapidly provisioned via virtualization and released with low management effort or service provider interaction, and then scaled accordingly.

As a cloud-computing model can be composed of various characteristics such as, for example, on-demand self-service, broad network access, resource pooling, rapid elasticity, measured service, and so forth. A cloud-computing model can also expose various service models, such as, for example, Software as a Service (“SaaS”), Platform as a Service (“PaaS”), and Infrastructure as a Service (“IaaS”). A cloud-computing model can also be deployed using different deployment models such as private cloud, community cloud, public cloud, hybrid cloud, and so forth. In this description and in the claims, a “cloud-computing environment” is an environment in which cloud computing is employed.

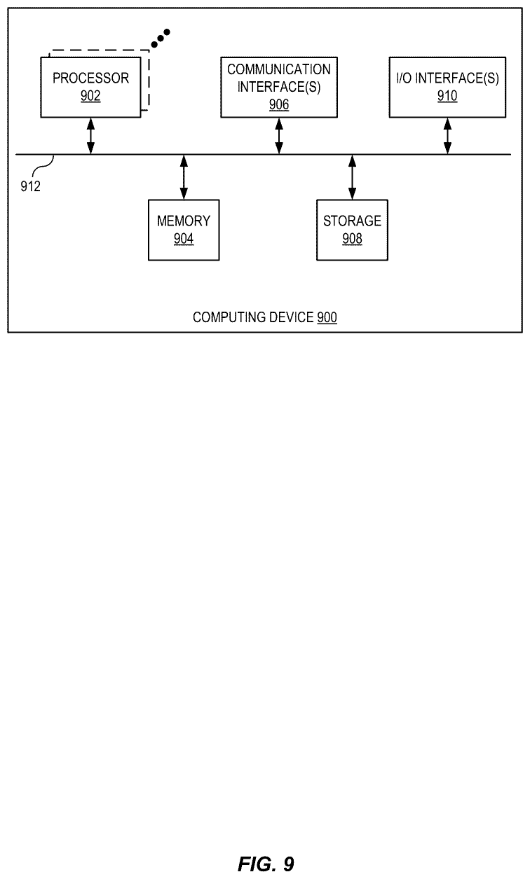

FIG. 9 illustrates, in block diagram form, an exemplary computing device 900 that may be configured to perform one or more of the processes described above. One will appreciate that one or more computing devices such as the computing device 900 may implement the vector graphics system 600. As shown by FIG. 9, the computing device can comprise a processor 902, memory 904, one or more communication interfaces 906, a storage device 908, and one or more I/O devices/interfaces 910. In certain embodiments, the computing device 900 can include fewer or more components than those shown in FIG. 9. Components of computing device 900 shown in FIG. 9 will now be described in additional detail.

In particular embodiments, processor(s) 902 includes hardware for executing instructions, such as those making up a computer program. As an example, and not by way of limitation, to execute instructions, processor(s) 902 may retrieve (or fetch) the instructions from an internal register, an internal cache, memory 904, or a storage device 908 and decode and execute them. In various embodiments, the processor(s) 902 may include one or more central processing units (CPUs), graphics processing units (GPUs), field programmable gate arrays (FPGAs), systems on chip (SoC), or other processor(s) or combinations of processors.

The computing device 900 includes memory 904, which is coupled to the processor(s) 902. The memory 904 may be used for storing data, metadata, and programs for execution by the processor(s). The memory 904 may include one or more of volatile and non-volatile memories, such as Random Access Memory (“RAM”), Read Only Memory (“ROM”), a solid-state disk (“SSD”), Flash, Phase Change Memory (“PCM”), or other types of data storage. The memory 904 may be internal or distributed memory.

The computing device 900 can further include one or more communication interfaces 906. A communication interface 906 can include hardware, software, or both. The communication interface 906 can provide one or more interfaces for communication (such as, for example, packet-based communication) between the computing device and one or more other computing devices 900 or one or more networks. As an example, and not by way of limitation, communication interface 906 may include a network interface controller (NIC) or network adapter for communicating with an Ethernet or other wire-based network or a wireless NIC (WNIC) or wireless adapter for communicating with a wireless network, such as a WI-FI. The computing device 900 can further include a bus 912. The bus 912 can comprise hardware, software, or both that couples components of computing device 900 to each other.

The computing device 900 includes a storage device 908 which includes storage for storing data or instructions. As an example, and not by way of limitation, storage device 908 can comprise a non-transitory storage medium described above. The storage device 908 may include a hard disk drive (HDD), flash memory, a Universal Serial Bus (USB) drive or a combination of these or other storage devices. The computing device 900 also includes one or more input or output (“I/O”) devices/interfaces 910, which are provided to allow a user to provide input to (such as user strokes), receive output from, and otherwise transfer data to and from the computing device 900. These I/O devices/interfaces 910 may include a mouse, keypad or a keyboard, a touch screen, camera, optical scanner, network interface, modem, other known I/O devices or a combination of such I/O devices/interfaces 910. The touch screen may be activated with a stylus or a finger.

The I/O devices/interfaces 910 may include one or more devices for presenting output to a user, including, but not limited to, a graphics engine, a display (e.g., a display screen), one or more output drivers (e.g., display drivers), one or more audio speakers, and one or more audio drivers. In certain embodiments, I/O devices/interfaces 910 is configured to provide graphical data to a display for presentation to a user. The graphical data may be representative of one or more graphical user interfaces and/or any other graphical content as may serve a particular implementation.

In the foregoing specification, embodiments have been described with reference to specific exemplary embodiments thereof. Various embodiments are described with reference to details discussed herein, and the accompanying drawings illustrate the various embodiments. The description above and drawings are illustrative of one or more embodiments and are not to be construed as limiting. Numerous specific details are described to provide a thorough understanding of various embodiments.

Embodiments may include other specific forms without departing from its spirit or essential characteristics. The described embodiments are to be considered in all respects only as illustrative and not restrictive. For example, the methods described herein may be performed with less or more steps/acts or the steps/acts may be performed in differing orders. Additionally, the steps/acts described herein may be repeated or performed in parallel with one another or in parallel with different instances of the same or similar steps/acts. The scope of the invention is, therefore, indicated by the appended claims rather than by the foregoing description. All changes that come within the meaning and range of equivalency of the claims are to be embraced within their scope.

In the various embodiments described above, unless specifically noted otherwise, disjunctive language such as the phrase “at least one of A, B, or C,” is intended to be understood to mean either A, B, or C, or any combination thereof (e.g., A, B, and/or C). As such, disjunctive language is not intended to, nor should it be understood to, imply that a given embodiment requires at least one of A, at least one of B, or at least one of C to each be present.

We claim:

1. A method comprising:
receiving an image including at least one object having a pose, the pose defined by an orientation and a position of the object within the image;
generating a set of key joint data that represents the orientation and position of one or more points of interest associated with the object;
creating a vector representation of the set of key joint data for classifying one or more additional images that each include a candidate pose;
receiving the one or more additional images;
detecting a match between one of the candidate poses in the one or more additional images and the pose by comparing the vector representation of the set of key joint data to the candidate pose; and
generating a visual effect based on the match.

2. The method of claim 1, wherein generating a set of key joint data that represents the orientation and position of one or more points of interest for the object comprises:
applying a trained machine learning model to the image including the object, wherein applying the trained machine learning model comprises:
detecting a type of the object, the type indicating a set of points that are defined for each object;
detecting a position and orientation for each point in the set of points; and
inserting the position and orientation of each point into the set of key joint data.

3. The method of claim 2, wherein detecting a match between the candidate pose and the pose comprises:
comparing, by a node architecture, a key joint of the pose to a corresponding key joint of the candidate pose; and
determining, based on the comparison, that the key joint of the pose matches the corresponding key joint of the candidate pose.

4. The method of claim 3, wherein generating the visual effect based on the match comprises:
selecting a visual effect for insertion into the image; and
in response to determining, based on the comparison, that key joint of the pose matches the corresponding key joint of the candidate pose, inserting the selected visual effect into the image.

5. The method of claim 4, inserting the selected visual effect into the image comprises:
identifying an effect key joint of the pose where the visual effect is to be added; and
applying the visual effect at a position of the effect key joint in the image.

6. The method of claim 1 further comprising:
receiving a second image including at least one object having an additional pose, the additional pose defined by an additional orientation and an additional position of the object within the image;
generating an additional set of key joint data that represents the additional orientation and additional position of the one or more points of interest for the object;
creating a vector representation of the additional set of key joint data;
in response to receiving the one or more additional images, detecting an occurrence of the pose at a first time interval;
in response to receiving the one or more additional images, detecting an occurrence of the additional pose at a second time interval; and
generating a visual effect based on the occurrence of the pose and the additional pose.

7. The method of claim 6, wherein detecting an occurrence of the pose at a first time interval comprises comparing the vector representation of the additional set of key joint data to the set of key joint data that represents the orientation and position of one or more points of interest associated with the object.

8. A system comprising:
a memory component; and
a processing device coupled to the memory component, the processing device to perform operations comprising:
receiving an image including at least one object having a pose, the pose defined by an orientation and a position of the object within the image;
generating a set of key joint data that represents the orientation and position of one or more points of interest associated with the object;
creating a vector representation of the set of key joint data for classifying one or more additional images that each include a candidate pose;
receiving the one or more additional images;
detecting a match between one of the candidate poses in the one or more additional images and the pose by comparing the vector representation of the set of key joint data to the candidate pose; and
generating a visual effect based on the match.

9. The system of claim 8, wherein the operation of generating a set of key joint data that represents the orientation and position of one or more points of interest for the object causes the processing device to perform operations comprising:
applying a trained machine learning model to the image including the object, wherein applying the trained machine learning model comprises:
detecting a type of the object, the type indicating a set of points that are defined for each object;
detecting a position and orientation for each point in the set of points; and
inserting the position and orientation of each point into the set of key joint data.

10. The system of claim 9, wherein the operation of detecting a match between the candidate pose and the pose causes the processing device to perform operations comprising:
comparing, by a node architecture, a key joint of the pose to a corresponding key joint of the candidate pose; and
determining, based on the comparison, that the key joint of the pose matches the corresponding key joint of the candidate pose.

11. The system of claim 10, wherein the operation of generating the visual effect based on the match causes the processing device to perform operations comprising:
selecting a visual effect for insertion into the image; and
in response to determining, based on the comparison, that key joint of the pose matches the corresponding key joint of the candidate pose, inserting the selected visual effect into the image.

12. The system of claim 11, wherein the operation of inserting the selected visual effect into the image causes the processing device to perform operations comprising:
identifying an effect key joint of the pose where the visual effect is to be added; and
applying the visual effect at a position of the effect key joint in the image.

13. The system of claim 8, the operations further comprising:
receiving a second image including at least one object having an additional pose, the additional pose defined by an additional orientation and an additional position of the object within the image;
generating an additional set of key joint data that represents the additional orientation and additional position of the one or more points of interest for the object;
creating a vector representation of the additional set of key joint data;
in response to receiving the one or more additional images, detecting an occurrence of the pose at a first time interval;
in response to receiving the one or more additional images, detecting an occurrence of the additional pose at a second time interval; and
generating a visual effect based on the occurrence of the pose and the additional pose.

14. The system of claim 13, wherein the operation of detecting an occurrence of the pose at a first time interval causes the processing device to perform operations comprising comparing the vector representation of the additional set of key joint data to the set of key joint data that represents the orientation and position of one or more points of interest associated with the object.

15. A non-transitory computer-readable medium storing executable instructions, which when executed by a processing device, cause the processing device to perform operations comprising:
receiving an image including at least one object having a pose, the pose defined by an orientation and a position of the object within the image;
generating a set of key joint data that represents the orientation and position of one or more points of interest associated with the object wherein the operation of generating a set of key joint data that represents the orientation and position of one or more points of interest for the object causes the processing device to perform operations comprising:
applying a trained machine learning model to the image including the object, wherein applying the trained machine learning model comprises:
detecting a type of the object, the type indicating a set of points that are defined for each object;
detecting a position and orientation for each point in the set of points; and
inserting the position and orientation of each point into the set of key joint data;
creating a vector representation of the set of key joint data for classifying one or more additional images that each include a candidate pose;
receiving the one or more additional images;
detecting a match between one of the candidate poses in the one or more additional images and the pose by comparing the vector representation of the set of key joint data to the candidate pose; and
generating a visual effect based on the match.

16. The non-transitory computer-readable medium of claim 15, wherein the operation of generating a set of key joint data that represents the orientation and position of one or more points of interest for the object causes the processing device to perform operations comprising:
applying a trained machine learning model to the image including the object, wherein applying the trained machine learning model comprises:
detecting a type of the object, the type indicating a set of points that are defined for each object;
detecting a position and orientation for each point in the set of points; and
inserting the position and orientation of each point into the set of key joint data.

17. The non-transitory computer-readable medium of claim 15, wherein the operation of detecting a match between the candidate pose and the pose of the object causes the processing device to perform operations comprising:
comparing, by a node architecture, a key joint of the pose to a corresponding key joint of the candidate pose; and
determining, based on the comparison, that the key joint of the pose matches the corresponding key joint of the candidate pose.

18. The non-transitory computer-readable medium of claim 15, wherein the operation of generating the visual effect based on the match causes the processing device to perform operations comprising:
selecting a visual effect for insertion into the image; and
in response to determining, based on the comparison, that key joint of the pose matches the corresponding key joint of the candidate pose, inserting the selected visual effect into the image.

19. The non-transitory computer-readable medium of claim 18, wherein the operation of inserting the selected visual effect into the image causes the processing device to perform operations comprising:
identifying an effect key joint of the pose where the visual effect is to be added; and
applying the visual effect at a position of the effect key joint in the image.

20. The non-transitory computer-readable medium of claim 15, the operations further comprising:
receiving a second image including at least one object having an additional pose, the additional pose defined by an additional orientation and an additional position of the object within the image;
generating an additional set of key joint data that represents the additional orientation and additional position of the one or more points of interest for the object;
creating a vector representation of the additional set of key joint data;
in response to receiving the one or more additional images, detecting an occurrence of the pose at a first time interval, wherein detecting the occurrence of the pose at the first time interval causes the processing device to perform operations comprising comparing the vector representation of the additional set of key joint data to the vector representation of the set of key joint data that represents the orientation and position of one or more points of interest associated with the object;
in response to receiving the one or more additional images, detecting an occurrence of the additional pose at a second time interval; and
generating a visual effect based on the occurrence of the pose and the additional pose.
